(19) United States
(12) Patent Application Publication
(10) Pub. No.: US 2025/0050319 A1
(43) Pub. Date: Feb. 13, 2025

(54) CATALYTIC COMPOSITION IN THE FORM OF A PICKERING EMULSION

(71) Applicant: IFP ENERGIES NOUVELLES, Rueil-Malmaison (FR)

(72) Inventors: Corinne BURNICHON, Rueil-Malmaison Cedex (FR); Christine DALMAZZONE, Rueil-Malmaison Cedex (FR); Cyril DARTIGUELONGUE, Rueil-Malmaison Cedex (FR); Severine FORGET, Rueil-Malmaison Cedex (FR); Lionel MAGNA, Rueil-Malmaison Cedex (FR)

(73) Assignee: IFP ENERGIES NOUVELLES, Rueil-Malmaison (FR)

(21) Appl. No.: 18/721,931

(22) PCT Filed: Dec. 12, 2022
(86) PCT No.: PCT/EP2022/085454

§ 371 Date: Jun. 20, 2024

(30) Foreign Application Priority Data
Dec. 21, 2021 (FR) FR2114086

(51) Int. Cl. B01J 35/27; B01J 31/02; B01J 35/40

(52) U.S. Cl. CPC B01J 35/27; B01J 31/0279; B01J 31/0288; B01J 31/0289; B01J 35/40; B01J 2523/51; B01J 2523/62

(57) ABSTRACT

The present invention relates to a catalytic composition in the form of what is known as a Pickering emulsion, said composition comprising a first non-aqueous liquid phase L1 comprising hydrocarbon compounds, within which droplets of a second liquid phase L2 are stabilized by solid particles, said second liquid phase L2 comprising at least one ionic liquid of formula Q⁺A⁻, Q⁺ being an organic cation and A⁻ being an anion, and in which a Brønsted acid HB is dissolved.

### TECHNICAL FIELD

The present invention relates to a catalytic composition and to its use in acid catalysis processes.

It relates more particularly to a composition resulting from the dissolution of at least one Brønsted acid, denoted HB, in an ionic liquid medium comprising at least one organic cation Q⁺ and one anion A⁻.

The present invention also relates to acid catalysis processes using said composition, and more particularly to alkylation of aromatic hydrocarbons, oligomerization of olefins, isomerization of n-olefins to isoolefins, isomerization of n-paraffins to isoparaffins, and alkylation of isobutane by olefins.

### PRIOR ART

Acid catalysis reactions are very important industrial reactions, which find very varied applications in the field of refining and petrochemistry. Reference may be made in particular to the publication by Christian Marcilly, “Catalyse acido-basique—Application au raffinage et à la pétrochimie” [Acid-base catalysis—Application to refining and petrochemistry]—July 2003—Editions Technip, for more information on these reactions.

Mention may be made, by way of example, of the alkylation of aromatic hydrocarbons for the production of LABs, “linear alkyl benzenes”, which are intermediates for the synthesis of biodegradable detergents. Mention may also be made of the dimerization of isobutene to 2,4,4-trimethyl-1-pentene and 2,4,4-trimethyl-2-pentene which, after hydrogenation, leads to a desired additive for the reformulation of gasolines, 2,4,4-trimethylpentane (absence of sulfur, aromatic and olefin, high octane number, etc.).

The conventional acid catalysts used for these transformations are very often Lewis and/or Brønsted acids. The most commonly used are hydrofluoric acid (HF), concentrated sulfuric acid (H₂SO₄), boron trifluoride (BF₃) and aluminum trichloride (AlCl₃). However, the use of these acids has drawbacks, in particular because of the increasingly strict measures aimed at protecting the environment. For example, the use of HF, which is toxic, volatile and corrosive, involves the deployment of important safety measures for operators and equipment. Concentrated sulfuric acid, for its part, is not very active and requires the use of large volumes of acid, which generate discharges, essentially inorganic salts, which must be brought to environmental standards before being discharged. Aluminum trichloride, nevertheless still widely used industrially, pure or complexed with a base (often called “red oils”), is consumed in large quantities. However, this type of catalyst is not easily separated from the reaction products. From this point of view, solid catalysts such as zeolites or else sulfonic resins can provide an improvement as regards the separation of the products and the recycling of the catalyst, but they impose reaction temperatures which are often higher.

An alternative approach, for example described in patent FR 2 829 039, involves implementing this type of reactions and catalysts in the form of a two-phase liquid-liquid system: The Lewis acid and/or Brønsted acid is immobilized in an ionic liquid phase Q⁺A⁻, which is of low miscibility or immiscible with the reaction products. These products can then be separated by decantation, and the catalytic phase can then be recycled and reused. Catalyst consumption is thus reduced. However, these systems are not completely devoid of drawbacks: The viscosity of the ionic liquids entails, for example, the use of a mechanical energy that is high enough to ensure mixing between the two phases. The reaction selectivities can, moreover, be complicated to control, owing in particular to follow-on reactions linked to the partial miscibility of the primary products in the acidic ionic liquid. A follow-on reaction means a reaction where the reaction product reacts with the reactant to form a heavier, unwanted product.

An aim of the invention is in that case to improve the catalytic compositions in the form of a two-phase liquid-liquid system. The invention seeks in particular to improve their stability and/or to improve the yield and/or the selectivity of the desired reactions.

### SUMMARY OF THE INVENTION

A first subject of the invention is a catalytic composition in the form of what is known as a Pickering emulsion, said composition comprising a first non-aqueous liquid phase L1 comprising hydrocarbon compounds, within which droplets of a second liquid phase L2 are stabilized by solid particles, said second liquid phase L2 comprising at least one ionic liquid of formula Q⁺A⁻, Q⁺ being an organic cation and A being an anion, and in which a Brønsted acid HB is dissolved.

The liquid phase L2 may comprise a single ionic liquid, or several different ionic liquids in a mixture (having in that case a cation and/or an anion different from each other).

The invention has thus chosen to place the two-phase liquid/liquid catalytic composition in the form of a Pickering emulsion in order to stabilize it.

Specifically, Pickering emulsions are liquid/liquid dispersions stabilized by nanoparticles or aggregates of solid nanoparticles which accumulate at the interface between the two immiscible liquids (generally water and oil) and prevent coalescence (see, for example, the publication Pickering, S. U. (1907). J. Chem. Soc. Trans. 91, 2001-2021). In fact, the particles used to make Pickering emulsions are capable of irreversibly attaching to the interface between the two liquids, causing much more effective stabilization of the emulsion than the adsorption of surfactants (see, for example, the publication Aveyard, R., Binks, B. P., and Clint, J. H. (2003). Adv. Colloid Interface Sci. 100, 503-546.). The direction of the emulsion (water in oil or oil in water) is determined by the preferential wettability of the particles toward one or the other phase. In fact, the liquid which is the most wetting with respect to the particles will constitute the continuous phase of the emulsion, and the least wetting the dispersed phase (reference may be made, for example, to the publication Binks, B., and Lumsdon, S. (2000. Langmuir 16, 8622-8631).

The invention has been able to demonstrate that encapsulation of the ionic liquid phase Q⁺A⁻ containing the Brønsted acid HB, in the form of droplets in what is known as a Pickering emulsion, makes it possible, in particular, to obtain a very significant gain in selectivity compared with the two-phase system described above.

In addition, immobilization of the catalytic composition Q⁺A⁻/HB within a Pickering emulsion results in a whole range of other advantages, including more efficient use of the catalytic formulation Q⁺A⁻/HB, with, in particular, a reduction in the problems of liquid/liquid transfer and a reduction in the energy consumption required to achieve this transfer.

Specifically, in order to ensure the transfer a molecule between two liquid phases (when taking the dimerization of isobutene as an example, isobutene passes from the hydrocarbon phase to the ionic liquid phase), it is necessary to create a large exchange surface area between the two liquids. Conventionally, this can be done by vigorously stirring the system to bring the phases into contact, but this stirring requires a great deal of energy. In contrast, with a Pickering emulsion, the exchange surface area created is extremely large and, in addition, the emulsion remains stable after its creation; it is no longer necessary to supply energy to keep the two liquid phases in contact.

Immobilization of the catalytic composition Q⁺A⁻/HB within a Pickering emulsion provides another advantage: stabilization of the catalytic formulation Q⁺A⁻/HB in the form of droplets, making it easily recyclable. To do this, in certain cases it may be necessary to break the emulsion, but there are also methods of implementation in which the reaction can be carried out with an excess of continuous phase, with gentle stirring, then the stirring is halted and the emulsion is allowed to settle, the upper phase containing the products is removed and recharged with a new continuous phase containing the reactant. In this case, the emulsion can then be recycled without being broken. This is the concept known under the acronym PEOBS (for “Pickering Emulsion Organic Biphasic System”).

Another advantage of the invention is that it is possible to implement this system in a continuous reactor with a traversed bed.

Preferably, the organic cation Q⁺ is a quaternary ammonium and/or a quaternary phosphonium and/or a trialkylsulfonium.

More preferably, the anion A is an anion that forms with the cation Q⁺ a salt which is liquid below 150° C.

The anion A⁻ may in particular be chosen (alone or as a mixture of at least two of them) from the anions tetrafluoroborate, tetraalkylborate, hexafluorophosphate, hexafluoroantimonate, alkylsulfonate, in particular methylsulfonate, perfluoroalkylsulfonate, in particular trifluoromethylsulfonate, fluorosulfonate, sulfate, phosphate, perfluoroacetate, in particular trifluoroacetate, perfluorosulfonamide, in particular bis-trifluoromethanesulfonyl amide (CF₃SO₂)₂N—, fluorosulfonamide, perfluorosulfomethide, in particular tris-trifluoromethanesulfonyl methide (CF₃SO₂)₃C⁻ and carboranes.

The cation Q⁺ may be chosen from the following compounds (alone or as a mixture of at least two of them):

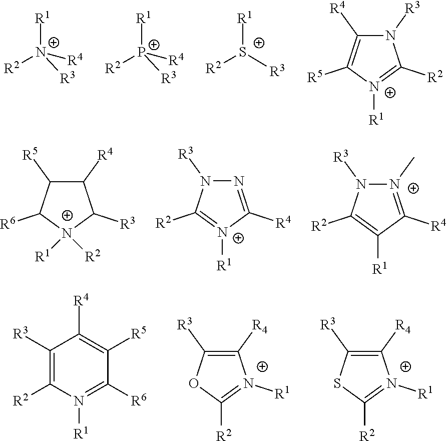

for which R¹, R², R³, R⁴, R⁵ and R⁶ are identical or different, bonded together or not, and represent hydrogen or hydrocarbyl groups having from 1 to 12 carbon atoms, in particular saturated or unsaturated alkyl groups, or cycloalkyl groups or aromatic, aryl or aralkyl, groups, comprising from 1 to 12 carbon atoms.

As examples of ionic liquids Q⁺A⁻ of interest according to the invention, mention may be made of N-butylpyridinium hexafluorophosphate, N-ethylpyridinium tetrafluoroborate, 3-butyl-1-methylimidazolium hexafluoroantimonate, 3-butyl-1-methylimidazolium hexafluorophosphate, 3-butyl-1-methylimidazolium trifluoromethylsulfonate, pyridinium fluorosulfonate, trimethylphenylammonium hexafluorophosphate, 3-butyl-1-methylimidazolium bis-trifluoromethylsulfonylamide, triethylsulfonium bis-trifluoromethylsulfonylamide, tributylhexylammonium bis-trifluoromethylsulfonylamide, 3-butyl-1-methylimidazolium trifluoroacetate, 3-butyl-1,2-dimethylimidazolium bis-trifluoromethylsulfonylamide. These salts can be used alone or as a mixture.

The Brønsted acids used according to the invention are defined as being acidic compounds capable of donating at least one proton. According to the invention, these Brønsted acids have the general formula HB, in which B represents an anion. Preferably, the Brønsted acid HB comprises an anion B chosen from the anions tetrafluoroborate, tetraalkylborates, hexafluorophosphate, hexafluoroantimonate, alkylsulfonates, in particular methylsulfonate, perfluorosulfonate, in particular trifluoromethylsulfonate, fluorosulfonate, sulfate, phosphate, perfluoroacetate, in particular trifluoroacetate, perfluorosulfonamide, in particular bis-trifluoromethanesulfonyl amide (CF₃SO₂)₂N—, fluorosulfonamide, perfluorosulfomethide, in particular tris-trifluoromethanesulfonyl methide (CF₃SO₂)₃C⁻ and carborane.

The catalytic composition may comprise just one or several of these Brønsted acids, thus with different anions B.

According to one embodiment of the invention, the Brønsted acid HB is of formula Q₂⁺A₂⁻, in which Q₂⁺ represents an organic cation comprising at least one sulfonic acid or carboxylic acid function, and A₂⁻ represents an anion, in particular the same anion as the anion A⁻ of the ionic liquid. Within the meaning of the invention, the term “sulfonic acid function” or “carboxylic acid function” means a hydrocarbyl substituent having from 1 to 12 carbon atoms, containing a sulfonic acid (—SO₃H) or carboxylic acid (—CO₂H) group grafted onto the cation Q₂⁺.

As examples of compositions Q₂⁺A₂⁻ of interest, mention may be made of 1-methyl-3-(2-ethylsulfonyl) imidazolium trifluoromethylsulfonate, 1-ethyl-3-(2-ethylcarboxyl) imidazolium bistriflylamide, N-butyl-N-(2-ethylsulfonyl) pyrrolidinium trifluoromethylsulfonate, N-ethyl-N-(2-ethylcarboxyl) pyrrolidinium bistriflylamide, (2-ethylsulfonyl)triethylammonium trifluoromethylsulfonate and triphenyl(3-propylsulfonyl)phosphonium para-toluenesulfonate.

According to the invention, the first liquid phase L1 can comprise one or more saturated hydrocarbons, in particular of linear or cyclic alkane type, and/or one or more unsaturated hydrocarbons, in particular of olefin or aromatic compound type. Said hydrocarbon or hydrocarbons preferably have between 3 and 20 carbon atoms, preferably between 5 and 9 carbon atoms. Preferably, the first phase L1 comprises only one or more hydrocarbons.

The first liquid phase L1 may be chosen from pentane, hexane, heptane, cyclohexane, methylcyclohexane, toluene and xylene, pure or as a mixture. Preferably, it is chosen from heptane, cyclohexane and methylcyclohexane.

In the case where the first liquid phase L1 is an unsaturated hydrocarbon, it may advantageously be chosen from the products of the acid catalysis reaction implemented (alkylbenzene, diisobutene, etc.). The initial emulsion is an ionic liquid-HB/reaction product emulsion. The product then constitutes the continuous phase. The procedure may then consist in introducing the reactant (for example isobutene) into the continuous phase, the reaction being carried out in the drops of ionic liquid as in the conventional case, the reaction products not being miscible with the ionic liquid phase, in contrast to the reactant which is soluble in both phases.

The solid particles which are suitable for the invention may be of various shapes and sizes (for example from a few nanometers to a few microns, in the form of beads that are or are not substantially spherical). They may be of a single type, or they may be used as a mixture of several types of particles. They can be modified to change their surface properties (in particular to modify their wettability).

Optionally, there may be provision to add at least one surfactant to the particles. This surfactant (or each of them if a mixture of surfactants is used) may be of anionic, cationic, nonionic or amphoteric type.

According to the invention, the solid particles may thus be chosen from: silica particles, preferably functionalized with hydrophobic hydrocarbon groups, clay particles, preferably modified with organic or amphiphilic molecules, magnetic nanoparticles, in particular of Fe₃O₄, carbon nanotubes, particles of graphene oxides, particles of synthetic polymers, such as polyethylene glycol (PEG), polystyrene (PS), polylactic acid (PLA), polycaprolactone (PCL), or latex particles, particles of a material of natural origin preferably chosen from hydroxyapatite, chitosan, cyclodextrin, dextran, particles in the form of cellulose nanocrystals or nanofibers, particles of biological material, in particular of food grade, preferably chosen from starch, zein, soy proteins, bacteria and yeasts.

Preferably, the ratio in the emulsion between the largest dimension of the droplets and the largest dimension of the solid particles is at least 100. (The largest dimension is understood to mean the diameter when the particles are substantially spherical).

Preferably, the largest dimension of the droplets is between 1 μm and 1000 μm, preferably between 2 μm and 100 μm, in particular between 10 μm and 50 μm. It should be noted that the size of the droplets is measured by optical microscopy (in particular by an Olympus BX51 with analySIS software for image analysis).

The content of solid particles relative to the second liquid phase L2 may be chosen from 0.1% to 10% by weight, in particular from 0.5% to 5% by weight, preferably from 1% to 3% by weight.

The ratio by volume between the second liquid phase L2 and the first liquid phase L1 is preferably between 2:1 and 1:10, preferably between 1:1 and 1:5.

The catalytic composition according to the invention preferably has a concentration of Brønsted acid HB within the second liquid phase L2 of between 0.05% and 40.0% by weight, preferably between 0.1% and 5% by weight.

Another subject of the invention is a process for preparing the catalytic composition as described above, which comprises the following steps:
dispersing solid particles in the first liquid phase L1, with stirring, in particular with magnetic or mechanical stirring,
preparing the second liquid phase L2 by adding Brønsted acid to the ionic liquid comprising at least one organic cation Q⁺ and one anion A⁻,
adding the second liquid phase L2 to the first liquid phase L1 with the supply of dispersive energy, in particular by mechanical stirring means, such as a rotor stator, a propeller stirrer, a static mixer, a colloid mill, a membrane system, an ultrasonic stirring means, as described for example in the Techniques de l′Ingénieur [Techniques of the Engineer] file J2153V1: Procédés d′émulsification—Techniques d′appareillage [Emulsification processes—Equipment techniques], by M. Poux and JP Canselier, Oct. 6, 2004, or else a microfluidic system as described for example in the Techniques de l′Ingénieur [Techniques of the Engineer] file J8010V1: Microfluidique et formulation—Emulsions et systèmes colloïdaux complexes [Microfluidics and formulation—Emulsions and complex colloidal systems], by V. Nardello-Rataj and J F Ontiveros, Oct. 5, 2019.

Another subject of the invention is an acid catalysis process which utilizes the catalytic composition as described above.

Another subject of the invention is an acid catalysis process which utilizes a catalytic composition in the form of what is known as a Pickering emulsion, said composition comprising a first non-aqueous liquid phase L1 comprising hydrocarbon compounds, within which droplets of a second liquid phase L2 are stabilized by solid particles, said second liquid phase L2 comprising at least one ionic liquid of formula Q⁺A⁻, Q⁺ being an organic cation and A being an anion, and in which a Brønsted acid HB is dissolved.

The acid catalysis process according to the invention preferably proceeds as follows: reactants are introduced in liquid or gaseous form into the catalytic composition, they interact with/dissolve in the droplets of the second liquid phase L2 to be converted into reaction products that are soluble in the first liquid phase L1. The reaction products are then extracted from said first liquid phase L1, depending on the case, by breaking the emulsion of the catalytic composition, for example by carrying out centrifugation, or without having to break the emulsion by operating sequentially, by using, for example, the PEOBS technique mentioned above.

The acid catalysis process according to the invention can be implemented in a closed, semi-open or continuous system, with one or more reaction stages.

The acid catalysis process according to the invention may be a process of alkylation of aromatic hydrocarbons, of oligomerization of olefins, of dimerization of isobutene, of isomerization of n-olefins to isoolefins, of isomerization of n-paraffins to isoparaffins, and of alkylation of isobutane by olefins.

According to a first embodiment, the acid catalysis process according to the invention may be a process of alkylation:
of aromatic hydrocarbons chosen from monocyclic aromatics, in particular benzene, and alkylbenzenes such as toluene, ethylbenzene, xylene, mesitylene, durene, or polycyclic aromatics, in particular naphthalene, alkylnaphthalenes and anthracene, it being possible for said aromatic hydrocarbons to be substituted by one or more alkyl, aryl, alkylaryl, alkoxy, aryloxy, cycloalkyl groups and/or by any group that does not interfere with the alkylation reaction,
with at least one alkylating agent in the form of olefins having a number of carbon atoms of from 2 to 20, these olefins preferably being chosen from ethylene, butenes, 1-hexene, 1-octene, 1-decene, 1-dodecene, 1-tetradecene, alone or as a mixture.

These olefins can be obtained, for example, in processes for producing alpha-olefins by oligomerization of ethylene or in processes for dehydrogenating paraffins.

These olefins can be used pure or diluted, in particular in an alkane.

In the case of a process of alkylation of aromatic hydrocarbons, the molar ratio between the alkylating agent and the aromatic hydrocarbon can range from 0.05 to 100, and preferably from 0.1 to 10.

The temperature at which the aromatic alkylation is carried out is preferably between −50° C. and 200° C., preferably being less than 100° C. and in particular between −20° C. and 50° C. The aromatic alkylation may be done in the presence or absence of vapor phase, and the reaction pressure is preferably the autogenous pressure.

The duration of the aromatic alkylation reaction is preferably between 1 minute and 10 hours.

According to a second embodiment, the acid catalysis process according to the invention may be an olefin isomerization process, in particular for isomerizing at least one olefin having from 4 to 30 carbon atoms.

According to a third embodiment, the acid catalysis process according to the invention may be a process for dimerizing isobutene, starting from isobutene, pure or mixed with other hydrocarbons, optionally in the presence of an alcohol or an ether.

The possible sources for the isobutene are diverse. The most common are the dehydrogenation of isobutane and the dehydration of tert-butyl alcohol. The isobutene may also originate from a C4 cut from FCC (“fluid catalytic cracking”) or from steam cracking. In the latter case, the isobutene may be used as a mixture with n-butenes, isobutane and butane. The process according to the invention then has the additional advantage of making it possible to selectively convert isobutene without having to separate it from the other constituents of the cut. Another advantage of the process according to the invention is that isobutene-butene co-dimerization can be limited. The isobutene may also come from a process for dehydrating biobased alcohol.

The temperature at which the isomerization or the dimerization is carried out is preferably between −50° C. to 200° C., being preferably less than 100° C.

The isomerization or dimerization process can advantageously be carried out by reactive distillation.

According to a fourth embodiment, the acid catalysis process according to the invention may be a process of alkylation of isoparaffin, in particular isobutane, with olefins, said olefins being chosen from at least one of the following olefins: ethylene, butenes, 1-hexene, 1-octene, 1-decene, 1-dodecene, 1-tetradecene, alone or as a mixture. These olefins can be obtained in processes for producing alpha-olefins by oligomerization of ethylene or in processes for dehydrogenating paraffins.

These olefins can be used pure or as a mixture. The isoparaffin and the olefin may be introduced (into the catalytic composition) separately or as a mixture.

In this isoparaffin alkylation process, the molar ratio between the isoparaffin and the olefin is advantageously between 2/1 and 100/1, preferably between 10/1 and 50/1, in particular between 5/1 and 20/1.

The temperature at which the alkylation of isoparaffin is carried out is preferably between −50° C. and 200° C., in particular between −20° C. and 30° C.

### DESCRIPTION OF THE EMBODIMENTS

The coalescence stability of the catalytic composition emulsion is evaluated by an optical method based on multiple light scattering. The analysis of the light transmission and backscattering signals (wavelength 880 nm) is carried out using a Turbiscan apparatus sold by the company Formulaction. The technique makes it possible to reveal possible sedimentation, creaming and coalescence phenomena. The apparatus is used to verify that there is no coalescence of the dispersed phase of the emulsion and to confirm the stability of the emulsion to coalescence.

Within the meaning of the present invention, the different embodiments presented can be used alone or in combination with one another, without any limit to the combinations.

For the purposes of the present invention, the various ranges of parameters for a given step, such as the pressure ranges and the temperature ranges, can be used alone or in combination. For example, for the purposes of the present invention, a preferred range of pressure values can be combined with a range of more preferred temperature values.

In the text hereinbelow, the expressions “of between . . . and . . . ” and “between . . . and . . . ” are equivalent and mean that the limiting values of the interval are included in the described range of values. Should such not be the case and should the limiting values not be included in the range described, such a clarification will be provided by the present invention.

The invention will be described in greater detail with the aid of the non-limiting examples below.

### EXAMPLES

### Example 1 (Comparative): Dimerization of Isobutene in a Two-Phase System

A Fisher-Porter tube with a volume of 50 ml, equipped with a magnetic bar and dried beforehand in an oven and evacuated under vacuum, is charged, under an argon atmosphere, with 5.6 g of 1-butyl-3-methylimidazolium bis(trifluoromethanesulfonyl)imide ([BMI][NTf₂]) and 0.014 g of HNTf₂ acid. The mixture is stirred for a few minutes and a clear solution containing 0.3% by weight of HNTf₂ acid is obtained. 1.25 g of tetradecane (deaerated beforehand, with a water content of less than 10 ppm) are then added, this serving as internal standard. (As a reminder, the role of the internal standard is as follows: The internal standard is a compound inert with respect to the chemical reaction carried out, which is introduced in a known amount into the reaction medium. It makes it possible to measure the amount of products formed after reaction, by gas chromatography, as follows (schematically): the chromatographic area of the internal standard peak, which corresponds to the mass which was initially introduced, is measured, then the area of the products is measured, and by rule of three the mass of these products is deduced therefrom). 44 g of a liquid feedstock containing 12% by weight of isobutene and 88% by weight of n-heptane, i.e. 5.28 g of isobutene, are then introduced at ambient temperature. Stirring is then started (time zero of the reaction). After reacting for 10 minutes at 25° C., the stirring is stopped. The pressure is evacuated and the Fisher-Porter tube is opened in order to remove a few milliliters of the supernatant organic phase. The latter is analyzed by gas chromatography (PONA column) after treatment with sodium hydroxide (0.1 M) in order to eliminate possible traces of acid followed by drying over MgSO₄.

The isobutene conversion becomes established at 36%. The selectivity for dimerization products (trimethyl-2,4,4-pentenes) and trimerization products (C12) is 60% and 40%, respectively.

### Example 2 (Comparative): Dimerization of Isobutene in a Two-Phase System

The catalytic test is carried out in the same way as in example 1, except that the reaction time is increased to 60 min. The isobutene conversion becomes established at 88%. The selectivity for dimerization products (trimethyl-2,4,4-pentenes) and trimerization products (C12) is 51% and 49%, respectively.

### Example 3 (According to the Invention): Preparation of the Pickering Emulsion [BMI][NTf₂]/HNTF₂/SiO₂/Heptane

5.13 g of n-heptane, constituting the first liquid phase L1, were introduced into a beaker under an inert atmosphere.

Then 0.145 g of solid silica particles, which in this case are silica fume particles with the commercial reference Aerosil R972, sold by Evonik.

These particles, which are functionalized with dimethyldichlorosilane groups, are dispersed in n-heptane with magnetic stirring.

In a burette, the second liquid phase L2 is prepared: a mixture consisting of 5.6 g of 1-butyl-3-methylimidazolium bis(trifluoromethanesulfonyl)imide ([BMI][NTf2]) and 0.014 g of HNTf2 acid. This mixture (second liquid phase L2) is poured dropwise into the beaker containing the n-heptane (first liquid phase L1) and the silica particles, with continuous application of dispersion energy provided by a rotor-stator system (UltraTurrax device, sold by the company IKA, 000 rpm).

The Pickering emulsion thus obtained contains 2.5% by mass of silica particles relative to the dispersed ionic liquid phase (L2). The emulsion thus produced has a number-average droplet size of 20 μm, with a minimum diameter of 9 μm and a maximum diameter of 54 μm. No coalescence was detected by the Turbiscan apparatus according to the method described above.

### Example 4 (According to the Invention): Dimerization of Isobutene Using the Pickering Emulsion System Described in Example 3

A Fisher-Porter tube with a volume of 50 ml, equipped with a magnetic bar and dried beforehand in an oven and evacuated under vacuum, is charged, under an argon atmosphere, with all of the Pickering emulsion prepared according to example 3, and also 1.18 g of tetradecane (deaerated beforehand, with a water content of less than 10 ppm), which serves as internal standard. 42.2 g of a liquid feedstock containing 12% of isobutene and 88% of n-heptane, i.e. 5.06 g of isobutene, are then introduced at ambient temperature. Stirring is then started (time zero of the reaction). The reaction starts.

After reacting for 10 minutes at 25° C., the stirring is stopped. The pressure is evacuated and the Fisher-Porter tube is opened in order to remove a few milliliters of the supernatant organic phase that appears above the emulsion. To do this, the emulsion is allowed to settle at the bottom of the Fischer-Porter tube, and the upper phase containing the products is taken for analysis.

In order to measure the conversion and the selectivity, it is specifically merely necessary to take a sample that is representative of the continuous phase. (To recover all the products obtained, the entirety can be centrifuged.)

This sample is analyzed by gas chromatography (PONA column) after treatment with sodium hydroxide (0.1 M) in order to eliminate possible traces of acid and drying over MgSO₄.

The isobutene conversion becomes established at 35%. The selectivity for dimerization products (trimethyl-2,4,4-pentenes) and trimerization products (C12) is 91% and 9%, respectively.

### Example 5 (According to the Invention): Dimerization of Isobutene Using the Pickering Emulsion System Described in Example 3

The catalytic test is carried out in the same way as in example 4, except that the reaction time is increased to 60 min. The isobutene conversion becomes established at 88%. The selectivity for dimerization products (trimethyl-2,4,4-pentenes) and trimerization products (C12) is 74% and 26%, respectively.

Table 1 below shows all the results obtained on the basis of examples 1 to 5. It reveals the very significant impact of the invention on the control of the selectivity for dimerization product: specifically, the comparative examples have a dimer selectivity/trimer selectivity ratio of at most 1.50 (example 1), while the examples according to the invention have a ratio of at least 2.84 (example 5) up to 10 (example 4), and therefore a selectivity that is at least virtually doubled.

TABLE 1

| | | Time | Conversion | Dimer sel. | Trimer sel. |
|---|---|---|---|---|---|
| | Feedstock | (min) | (% by wt.) | (% by weight) | (% by weight) |
| Example 1 | isobutene | 10 | 36 | 60 | 40 |
| (comparative) | | | | | |
| Example 2 | isobutene | 60 | 88 | 51 | 49 |
| (comparative) | | | | | |
| Example 4 | Isobutene | 10 | 35 | 91 | 9 |
| (according to | | | | | |
| the invention) | | | | | |
| Example 5 | Isobutene | 60 | 88 | 74 | 26 |
| (According to | | | | | |
| the invention) | | | | | |

### Example 6 (Comparative): Dimerization of an Isobutene/1-Butene Mixture in a Two-Phase System

A Fisher-Porter tube with a volume of 50 ml, equipped with a magnetic bar and dried beforehand in an oven and evacuated under vacuum, is charged, under an argon atmosphere, with 5.6 g of 1-butyl-3-methylimidazolium bis(trifluoromethanesulfonyl)imide ([BMI][NTf₂]) and 0.014 g of HNTf₂ acid. The mixture is stirred for a few minutes and a clear solution containing 0.3% by weight of HNTf₂ acid is obtained. 1.57 g of tetradecane (deaerated beforehand, water content less than 10 ppm) are then added, this serving as internal standard. 37.7 g of a liquid feedstock containing 9.7% by weight of isobutene, 10% by weight of 1-butene, 5% by weight of n-butane (internal standard) and 75% by weight of n-heptane, i.e. 3.66 g of isobutene and 3.77 g of 1-butene, are then introduced at ambient temperature. Stirring is then started (time zero of the reaction). After reacting for 10 minutes at 25° C., the stirring is stopped. The pressure is evacuated, the gaseous phase is recovered in a balloon and analyzed by gas chromatography on an Alumina Plot column.

The Fisher-Porter tube is opened in order to remove a few ml of the supernatant organic phase. The latter is analyzed by gas chromatography (PONA column) after treatment with sodium hydroxide (0.1 M) in order to eliminate possible traces of acid and drying over MgSO₄.

The isobutene conversion becomes established at 32%, while the 1-butene conversion is only 5.4%. The selectivity for dimerization products (trimethyl-2,4,4-pentenes) and trimerization products (C12) is 67% and 33%, respectively.

### Example 7 (According to the Invention): Dimerization of an Isobutene/1-Butene Mixture in a Pickering Emulsion

A Fisher-Porter tube with a volume of 50 ml, equipped with a magnetic bar and dried beforehand in an oven and evacuated under vacuum, is charged, under an argon atmosphere, with all of the Pickering emulsion prepared according to example 3, and also 1.51 g of tetradecane (deaerated beforehand, with a water content of less than 10 ppm), which serves as internal standard. 36.2 g of a liquid feedstock containing 9.7% by weight of isobutene, 10% by weight of 1-butene, 5% by weight of n-butane (internal standard) and 75% by weight of n-heptane, i.e. 3.51 g of isobutene and 3.62 g of 1-butene, are then introduced at ambient temperature. Stirring is then started (time zero of the reaction). After reacting for 10 minutes at 25° C., the stirring is stopped. The pressure is evacuated, the gaseous phase is recovered in a balloon and analyzed by gas chromatography on an Alumina Plot column. The Fisher-Porter tube is opened in order to remove a few ml of the supernatant organic phase. The latter is analyzed by gas chromatography (PONA column) after treatment with sodium hydroxide (0.1 M) in order to eliminate possible traces of acid and drying over MgSO₄.

The isobutene conversion becomes established at 34%, while the 1-butene conversion is only 5.1%. The selectivity for dimerization products (trimethyl-2,4,4-pentenes) and trimerization products (C12) is 93% and 7%, respectively.

Table 2 below shows all the results obtained on the basis of examples 6 to 7.

TABLE 2

| | | | Conversion | Dimer sel. | Trimer sel. |
|---|---|---|---|---|---|
| | | Time | iC4⁼/C4⁼¹ | (% by | (% by |
| | Feedstock | (min) | (% by wt.) | weight) | weight) |
| Example 6 | Isobutene/1-butene | 10 | 32/5.4 | 67 | 33 |
| (comparative) | | | | | |
| Example 7 | Isobutene/1-butene | 10 | 34/5.1 | 93 | 7 |
| (according to the | | | | | |
| invention) | | | | | |

It reveals the very significant impact of the invention on the control of the selectivity: specifically, comparative example 6 exhibits a dimer selectivity/trimer selectivity ratio of 2.03, while example 7 according to the invention exhibits a ratio of 13.29, and therefore a selectivity that is multiplied by a factor of 6.5.

1. A catalytic composition in the form of what is known as a Pickering emulsion, said composition comprising a first non-aqueous liquid phase L1 comprising hydrocarbon compounds, within which droplets of a second liquid phase L2 are stabilized by solid particles, said second liquid phase L2 comprising at least one ionic liquid of formula Q⁺A⁻, Q⁺ being an organic cation and A being an anion, and in which a Brønsted acid HB is dissolved.

2. The catalytic composition as claimed in claim 1, characterized in that the organic cation Q⁺ is a quaternary ammonium and/or a quaternary phosphonium and/or a trialkylsulfonium, and in that the anion A⁻ is an anion that forms with the cation Q⁺ a salt which is liquid below 150° C.

3. The catalytic composition as claimed in claim 1, characterized in that the anion A⁻ is chosen from the anions tetrafluoroborate, tetraalkylborate, hexafluorophosphate, hexafluoroantimonate, alkylsulfonate, in particular methylsulfonate, perfluoroalkylsulfonate, in particular trifluoromethylsulfonate, fluorosulfonate, sulfate, phosphate, perfluoroacetate, in particular trifluoroacetate, perfluorosulfonamide, in particular bis-trifluoromethanesulfonyl amide (CF₃SO₂)₂N—, fluorosulfonamide, perfluorosulfomethide, in particular tris-trifluoromethanesulfonyl methide (CF₃SO₂)₃C⁻ and carboranes.

4. The catalytic composition as claimed in claim 1, characterized in that the cation Q⁺ is chosen from the following compounds 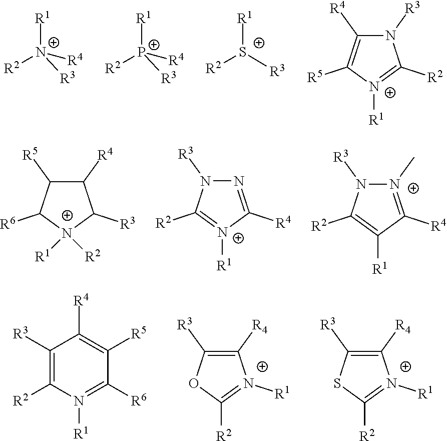
for which R¹, R², R³, R⁴, R⁵ and R⁶ are identical or different, bonded together or not, and represent hydrogen or hydrocarbyl groups having from 1 to 12 carbon atoms, in particular saturated or unsaturated alkyl groups, or cycloalkyl groups or aromatic, aryl or aralkyl, groups, comprising from 1 to 12 carbon atoms.

5. The catalytic composition as claimed in claim 1, characterized in that the Brønsted acid HB comprises an anion B chosen from the anions tetrafluoroborate, tetraalkylborates, hexafluorophosphate, hexafluoroantimonate, alkylsulfonates, in particular methylsulfonate, perfluorosulfonate, in particular trifluoromethylsulfonate, fluorosulfonate, sulfate, phosphate, perfluoroacetate, in particular trifluoroacetate, perfluorosulfonamide, in particular bis-trifluoromethanesulfonyl amide (CF₃SO₂)₂N—, fluorosulfonamide, perfluorosulfomethide, in particular tris-trifluoromethanesulfonyl methide (CF₃SO₂)₃C⁻ and carborane.

6. The catalytic composition as claimed in claim 1, characterized in that the Brønsted acid HB has the formula Q₂⁺A₂⁻, in which Q₂⁺ represents an organic cation comprising at least one sulfonic acid or carboxylic acid function, and A₂⁻ represents an anion, in particular the same anion as the anion A⁻ of the ionic liquid.

7. The catalytic composition as claimed in claim 1, characterized in that the first liquid phase L1 comprises one or more saturated hydrocarbons, in particular of linear or cyclic alkane type, and/or one or more unsaturated hydrocarbons, in particular of olefin or aromatic compound type, said hydrocarbon or hydrocarbons preferably having between 3 and 20 carbon atoms.

8. The catalytic composition as claimed in claim 1, characterized in that the solid particles are chosen from: silica particles, preferably functionalized with hydrophobic hydrocarbon groups, clay particles, preferably modified with organic or amphiphilic molecules, magnetic nanoparticles, in particular of Fe₃O₄, carbon nanotubes, particles of graphene oxides, particles of synthetic polymers, particles of a material of natural origin preferably chosen from hydroxyapatite, chitosan, cyclodextrin, dextran, particles in the form of cellulose nanocrystals or nanofibers, particles of biological material, in particular of food grade, preferably chosen from starch, zein, soy proteins, bacteria and yeasts, with the optional addition to the particles of at least one surfactant.

9. The catalytic composition as claimed in claim 1, characterized in that the largest dimension of the droplets is between 1 μm and 1000 μm, preferably between 2 μm and 100 μm, in particular between 10 μm and 50 μm.

10. The catalytic composition as claimed in claim 1, characterized in that the content of solid particles relative to the second liquid phase L2 is from 0.1% to 10% by weight, in particular from 0.5% to 5% by weight, preferably from 1% to 3% by weight.

11. The catalytic composition as claimed in claim 1, characterized in that the ratio by volume between the second liquid phase L2 and the first liquid phase L1 is between 2:1 and 1:10, preferably between 1:1 and 1:5.

12. The catalytic composition as claimed in claim 1, characterized in that the concentration of Brønsted acid HB within the second liquid phase L2 is between 0.05% and 40.0% by weight, preferably between 0.1% and 5% by weight.

13. A process for preparing the catalytic composition as claimed in claim 1, characterized in that it comprises the following steps:
dispersing solid particles in the first liquid phase L1, with stirring, in particular with magnetic or mechanical stirring,
preparing the second liquid phase L2 by adding Brønsted acid to the ionic liquid comprising at least one organic cation Q⁺ and one anion A⁻,
adding the second liquid phase L2 to the first liquid phase L1 with the supply of dispersive energy, in particular by mechanical stirring means, a colloid mill, a membrane system, an ultrasonic stirring means, a microfluidic system.

14. An acid catalysis process, characterized in that a catalytic composition in the form of what is known as a Pickering emulsion is used, said composition comprising a first non-aqueous liquid phase L1 comprising hydrocarbon compounds, within which droplets of a second liquid phase L2 are stabilized by solid particles, said second liquid phase L2 comprising at least one ionic liquid of formula Q⁺A⁻, Q⁺ being an organic cation and A⁻ being an anion, and in which a Brønsted acid HB is dissolved.

15. The process as claimed in claim 14, characterized in that it is a process of alkylation of aromatic hydrocarbons, of oligomerization of olefins, of dimerization of isobutene, of isomerization of n-olefins to isoolefins, of isomerization of n-paraffins to isoparaffins, and of alkylation of isobutane by olefins.
